(19) United States
(12) Patent Application Publication
(10) Pub. No.: US 2024/0237063 A1
(43) Pub. Date: Jul. 11, 2024

(54) PRIORITY-BASED TRANSMISSIONS AND CANCELLATION INDICATIONS IN SEMI-STATIC CHANNEL ACCESS MODE

(71) Applicant: Intel Corporation, Santa Clara, CA (US)

(72) Inventors: Salvatore TALARICO, Santa Clara, CA (US); Debdeep CHATTERJEE, San Jose, CA (US); Yi WANG, Santa Clara, CA (US); Toufiqul ISLAM, Santa Clara, CA (US); Sergey PANTELEEV, Kildare (IE)

(21) Appl. No.: 18/559,012

(22) PCT Filed: Sep. 30, 2022
(86) PCT No.: PCT/US2022/045438

§ 371 Date: Nov. 3, 2023

Related U.S. Application Data
(60) Provisional application No. 63/251,462, filed on Oct. 1, 2021.
(60) Provisional application No. 63/275,381, filed on Nov. 3, 2021.
(60) Provisional application No. 63/276,428, filed on Nov. 5, 2021.

(51) Int. Cl. H04W 74/0808; H04W 74/00

(52) U.S. Cl. CPC H04W 74/0808; H04W 74/004

(57) ABSTRACT

Various embodiments herein are directed to priority-based transmissions and cancellation indications in semi-static channel access mode. Other embodiments may be disclosed or claimed.

### CROSS REFERENCE TO RELATED APPLICATION

The present application claims priority to U.S. Provisional Patent Application No. 63/251,462, which was filed Oct. 1, 2021; U.S. Provisional Patent Application No. 63/275,381, which was filed Nov. 3, 2021 and to U.S. Provisional Patent Application No. 63/276,428, which was filed Nov. 5, 2021.

### FIELD

Various embodiments generally may relate to the field of wireless communications. For example, some embodiments may relate to priority-based transmissions and cancellation indications in semi-static channel access mode.

### BACKGROUND

The achievable latency and reliability performance of new radio (NR) systems are aspects of supporting use cases with tighter requirements. In order to extend the NR applicability in various verticals in Rel-16, NR evolved to support use cases including the following:
Release 15 enabled use case improvements
   Such as AR/VR (Entertainment industry)
New Release 16 use cases with higher requirements
   Factory automation
   Transport Industry
   Electrical Power Distribution

However, in some of the scenarios listed above, one of the major limiting factors is still the availability in spectrum. To mitigate this, one of the objectives of Rel. 17 is to identify potential enhancements to ensure Release 16 feature compatibility with unlicensed band URLLC/IIoT operation in controlled environment. Embodiments of the present disclosure address these and other issues.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an RB-based interlace structure in accordance with various embodiments.

FIG. 2 illustrates an example of an overlapping low priority (LP) UL transmission (PUXCH), which is initially meant to occur within a g-FFP, and a high priority (HP) UL transmission (PUXCH) which occurs starting from the UE's FPP and should be performed by the UE as if this operates as initiating device in accordance with various embodiments.

FIG. 3 illustrates an example of an overlapping LP UL transmission (PUXCH) and an HP UL transmission (PUXCH) which should be performed by the UE as if this operates as initiating device when the LP PUXCH occurs starting from the UE's FPPin accordance with various embodiments.

FIG. 4 illustrates an example of intra-symbol starting position for CG transmissions in accordance with various embodiments.

FIG. 5 illustrates an example of a case when the system operates at 20 MHz BW with 30 KHz subcarrier spacing (SCS) in accordance with various embodiments. In this case, when the RRC parameter timeFrequencyRegion is configured, 5 interlaces are available. In this figure, the gNB intends to cancel PUSCH3 occurring in interlace 2 within the time-frequency resources within the UL CI region (between OFDM symbol #1 to #4).

FIG. 6 illustrates an example of a case when the system operates at 40 MHz BW with 30 KHz SCS in accordance with various embodiments. In this case, when the RRC parameter timeFrequencyRegion is configured, 5 interlaces are available. In this figure, the gNB intends to cancel PUSCH3 occurring in interlace 2 in RB set I within the time-frequency resources within the UL CI region (between OFDM symbol #1 to #4).

FIG. 7 illustrates an example of a case when a UE operates as responding device and the nominal repetition overlaps with a set of symbols belonging to the idle period associated to the gNB's FFP in accordance with various embodiments. In this case, the time between when the UE determines that Rep #3 should be performed as if the UE operates as a responding device and the first symbol of this nominal repetition, indicated by T, is smaller than the PUSCH preparation time T_{proc,2}. In this case, given that T<T_{proc,2}, the UE drops Rep #3.

FIG. 8 illustrates an example of a case when a UE operates as initiating device and the nominal repetition overlaps with a set of symbols belonging to the UE's idle period in accordance with various embodiments. In this specific case, the UE is configured to perform four back-to-back repetitions, and the time between when the UE determines that Rep #4 should be performed as if the UE operates as an initiating device and the first symbol of this nominal repetition, indicated by T, is larger than the PUSCH preparation time T_{proc,2}. In this case, given that T>T_{proc,2}, the UE performs segmentation of Rep #4 across the idle period.

FIG. 9 schematically illustrates a wireless network in accordance with various embodiments.

FIG. 10 schematically illustrates components of a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 12, 13, and 14 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

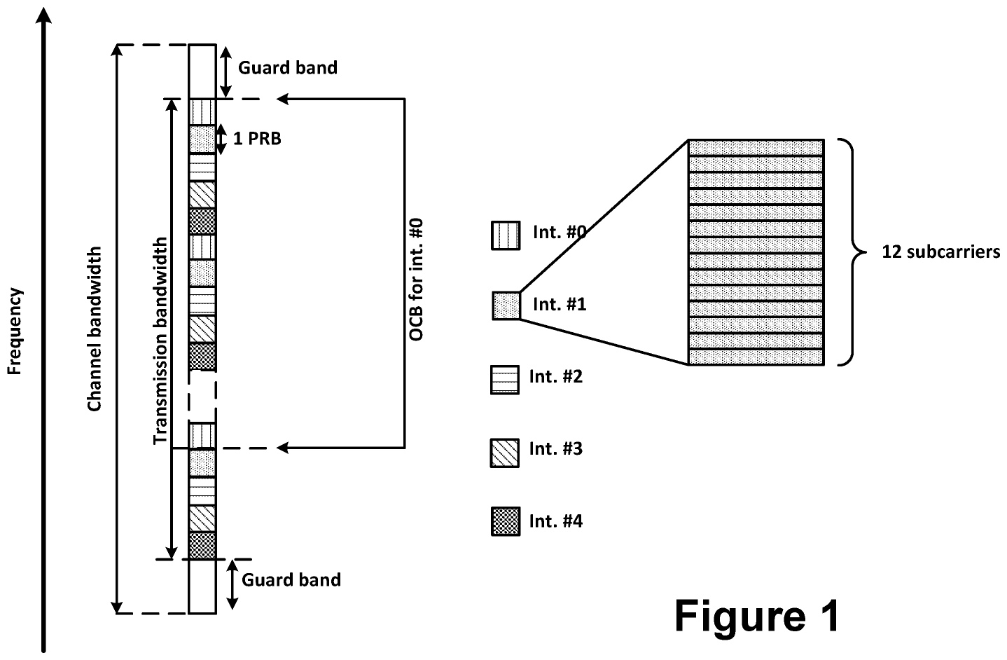

As introduced above, one of the objectives of Rel. 17 is to identify potential enhancements to ensure Release 16 feature compatibility with unlicensed band URLLC/IIoT operation in controlled environment. In this matter, it is important to identify aspects of the design that can be enhanced when operating in unlicensed spectrum. One of the challenges is that the system must comply with the regulatory requirements dictated for the sub-6 GHz band, where a listen before talk (LBT) procedure needs to be performed in some parts of the world to acquire the medium before a transmission can occur as described in ETSI EN 301 893, while still being able to guarantee the requirements in terms of reliability and latency identified for the design of URLLC/IIoT to meet the aforementioned use cases. Furthermore, on top of the mandatory LBT, the ETSI EN 301 893 mandates a minimum occupancy channel bandwidth within each LBT bandwidth of 20 MHZ, which led in Rel. 16 to define the UL resource allocation type 2 to comply with this requirement. The UL resource allocation type 2 defines the concept of interlace-based resource allocation for PUCCH and PUSCH transmissions which is enabled and used if useInterlacePUCCH-PUSCH is configured. In this case, a UE may be allocated with non-contiguous PRB allocation based on a specific pattern as illustrated in FIG. 1.

Given the aforementioned constrains and design choices that were made in Rel. 16 for NR-U, when operating URLLC/IIoT in the unlicensed spectrum these considerations should be also taken into account when harmonizing the design between Rel. 16 URLLC and Rel. 16 NR-U.

For instance, in Rel. 16 URLLC a cancellation procedure has been established to cancel a specific UL transmission over specified time/frequency domain resources in order to allow a gNB to schedule an UL transmission with higher priority or allow to schedule a different UE. However, the cancellation indication procedure has been designed having in mind the resources allocation type 1 for which the frequency domain resources that are allocated to a UE are contiguous, rather than spread along a system bandwidth as required when operating in shared spectrum when useInterlacePUCCH-PUSCH is configured. In this matter, if the system is operating in shared spectrum when useInterlacePUCCH-PUSCH is configured, and the cancellation procedure is used as is, the cancellation of an allocated interlace may require the gNB to provide a cancellation indication for each of the PRBs that compose the interlace, which would substantially increase the overhead of DCI format 2_4, which carries this information. For this purpose, one of the aims of various embodiments herein is to provide multiple solutions to mitigate this issue, and optimize the cancellation indication when operating in shared spectrum and useInterlacePUCCH-PUSCH is configured.

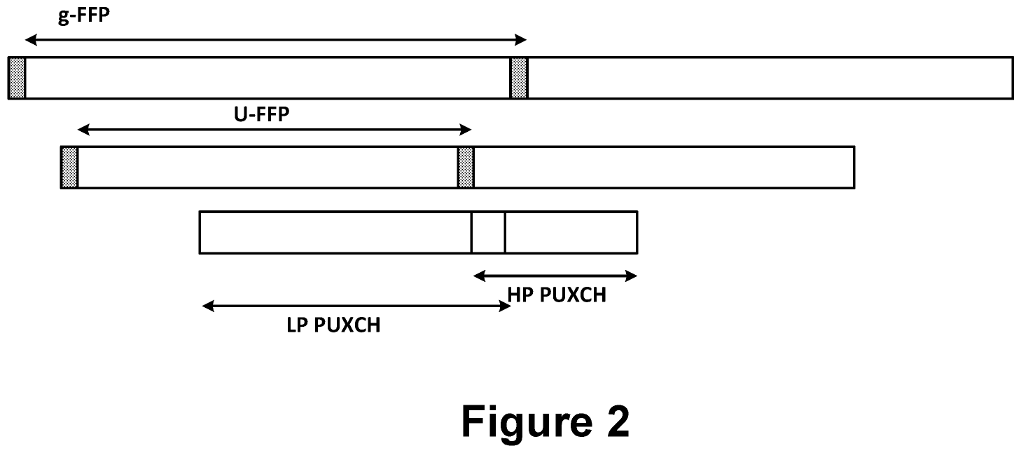

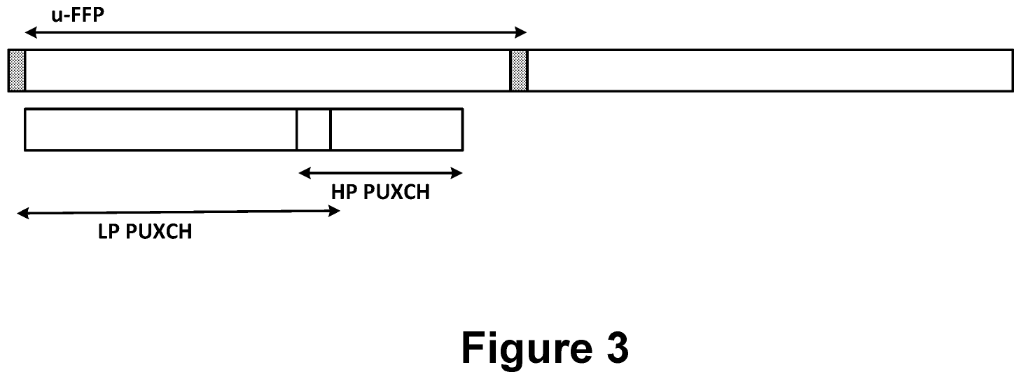

Furthermore, while during this working item RANI established the foundation for the framework to allow a UE to operate as initiating device in semi-static channel access mode, no discussions have been yet held on how to support priority based transmissions, and how the current framework may fit the Rel. 16 dropping rules when the low priority (LP) or high priority (HP) transmissions may align with the UE's fix frame period (FFP) boundary or overlap a UE's idle period (u-FFP). In this matter, FIG. 2 and FIG. 3 depict two cases where an HP transmission may be prevented from occurring if the UE operate as initiating device.

FIG. 2 illustrates an example of a case when an LP UL transmission (e.g., dynamic grant. configured grant or PUCCH transmission) overlaps with an HP UL transmission, where the HP UL transmission occurs starting from the UE's FPP and should be performed as if the UE operates as an initiating device. In this case, if the LP transmission is not completely dropped, the HP transmission cannot take place since this will block the UE from acquiring the UE's FFP within which the HP transmission should be performed. Also if the LP PUSCH is not dropped, the HP PUSCH could not be performed not only as if the UE operates as initiating device, but also even if the UE operates as responding device, since the HP PUSCH will be overlapping with the gNB's idle period.

FIG. 3 illustrates an example of a case when a LP UL transmission overlaps with an HP UL transmission, where both the LP and HP UL transmission occurs as if the UE operates as an initiating device, and the LP transmission starts from the UE's FPP. In this case, if the LP transmission is indeed dropped, the HP transmission cannot take place since the u-FFP could be claimed to be acquired, given that after the channel contention assessment (CCA) procedure a transmission would not immediately follow. Various embodiments herein provide solutions to solve the aforementioned issues.

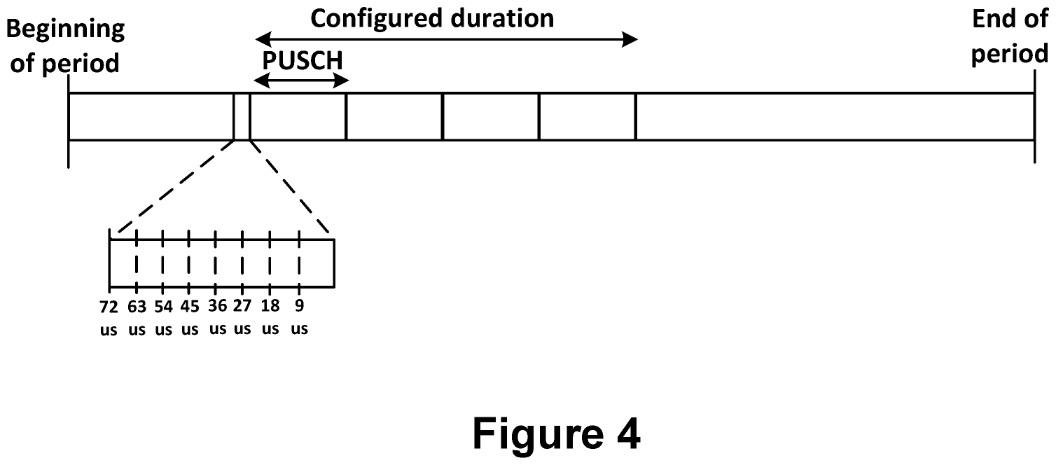

In this disclosure, it is also discussed on how to apply the intra-symbol starting positions when a UE operates as initiating device for the case when the UE operated both in full or partial BW. In particular, in Rel. 16 the concept of intra-symbols starting position has been introduced to mitigate mutual blocking among UEs. In this matter, a UE is mandated to start its transmission in a specific instance of time within the first OFDM symbol, which does not necessarily align with the OFDM boundary. In particular,
if a UE operates in full BW, the UE selects randomly the starting position for an UL transmission among a predefined subset, which is defined from a fixed set of values as illustrated in FIG. 4.
If a UE operates in partial BW, the UE is indicated to use a specific starting position when initiating an UL burst which is selected by the network a predefined set of values.

Additionally, given that in semi-static channel access mode a UE may need to perform a CCA during an idle period and start transmitting an UL burst exactly from the u-FFP boundary, the concept of intra-symbol starting position may need to be modified or precluded in some cases. In this matter a few options are provided in this disclosure.

To enable URLLC/IIoT design within the sub-6 GHz band some modifications might be required to some specific aspects of the design to ensure harmonization between the Rel. 16 NR-U and Rel. 16 URLLC design. In this matter, this disclosure provides many details on how to harmonize the cancellation indication procedure defined in Rel. 16 so that this works efficiently when the interlace-based resource allocation is used. Furthermore, along this disclosure multiple options are provided to ensure that the priority-based transmission rules introduced in Rel. 16 and Rel. 17 fit with the semi-static channel access framework defined in Rel. 17 to allow a UE to operate as initiating device. Lastly, this disclosure provides several options on how to apply the concept of intra-symbol starting position when a UE is allowed to operate as initiating device in semi-static channel access mode.

### Enhancements to Cancellation Indication Procedure

In Rel. 16 URLLC a cancellation procedure was established to cancel a specific UL transmission over specified time/frequency domain resources in order to allow a gNB to schedule UL transmission(s) from one or more different UE(s). However, the cancellation indication procedure has been designed having in mind the resources allocation type 1 (contiguous PRB allocation) for a single UE. However, when operating in semi-static channel access mode, the gNB may configure useInterlacePUCCH-PUSCH, for which a non-contiguous PRB allocation may be associated to a UE. In this case, in order to cancel a transmission a gNB may need to provide multiple cancellation indications indicating each a group of contiguous PRBs (which in some cases may require a number of bits larger than what DCI 2_4 can support) or by using a single cancellation indication it may cancel more resources and transmissions which may occur over other interlaces than necessary. As an example, if a UE is allocated a single interlace and operates over a 20 MHz bandwidth, the gNB may need 10 or 11 cancellation indications, one for each PRB that compose the allocated interlace. Through this example, it is easily possible to notice that the current cancellation indication is quite spectrally inefficient and when useInterlacePUCCH-PUSCH is configured this may lead to a very large overhead within the DCI format 2_4 used to cancel a transmission occurring in a specific interlace or group of interlaces, which becomes even more highlighted in case of multi-carrier operation. In order to mitigate this issue, in the following of this section multiple solutions/options are provided for both the case when a UE operates over a single carrier with interlace-based resource allocation, and when a UE operates in wideband mode over multiple carriers with interlace-based resource allocation.

### Single Carrier Operation With Interlace-Based Resource Allocation

In one embodiment, when operating in a shared spectrum in semi-static channel access mode with useInterlacePUCCH-PUSCH configured, and the UE receives a cancellation indication carried in DCI 2_4 with a CI-RNTI, the UE may be expected to cancel a transmission or transmissions over an entire interlace or group of interlaces if the indicated time-frequency resources that the gNB intends to cancel, which are indicated by DCI 2_4 and selected among the values configured in timefrequencyRegion, contain or refer to one or more PRBs belonging to that interlace or each of the interlaces within a group of interlaces.

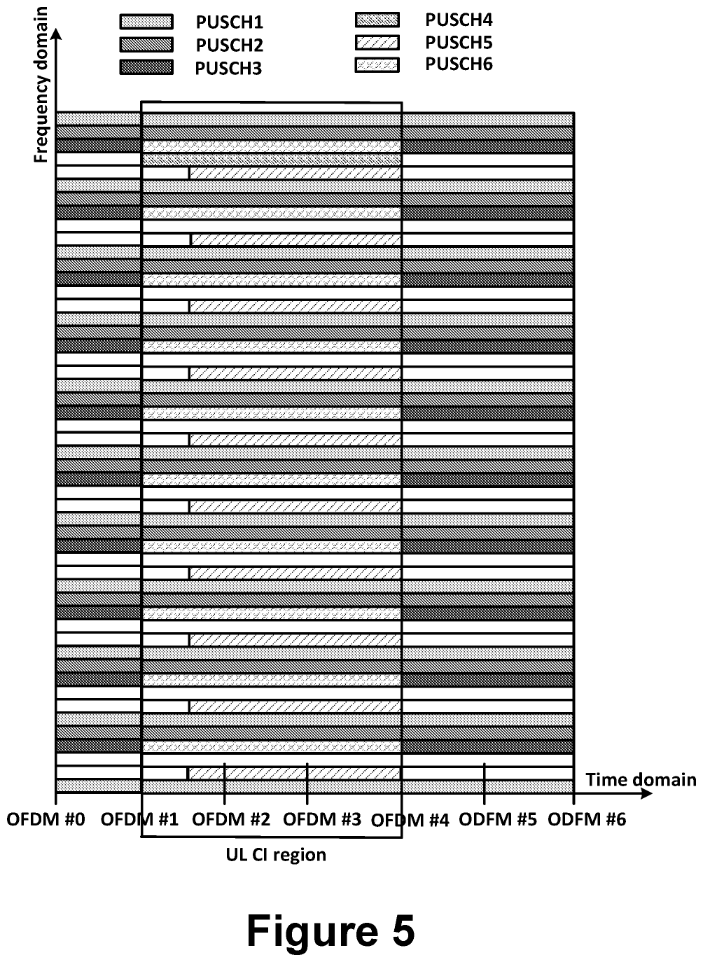

As an example, consider FIG. 5. If the gNB would like to cancel PUSCH 3 in the symbols indicated by the UL CI region depicted in green (between ODFM symbol #1 and #4) to allow PUSCH6 to be received reliably, the gNB may be only required to provide a cancellation indication referring to at least one PRB of the 10 PRBs composing interlace 2, and would not need to provide cancellation indication for each PRB that compose that interlace, for the UE to cancel PUSCH 3 within those time/frequency resources.

In one embodiment, when operating in shared spectrum in semi-static channel access mode with useInterlacePUCCH-PUSCH configured, and a UE is allocated a specific interlace for a transmission, for the UE to consider that interlace to be canceled within a time frame composed by a given number of symbols, the UE is expected to receive a cancellation indication for the interlace.

As an example, again consider FIG. 5. If the gNB would like to cancel PUSCH 3 at least in the symbols indicated by the UL CI region depicted in green, the gNB may provide a cancellation indication for Interlace 2 for OFDM symbol #1 to #4 for the UE to cancel PUSCH 3 in entirety or cancel PUSCH 3 at least within those time/frequency resources. In case the UE need to cancel PUSCH 3 in its entirety, the cancellation indication should refer to all the PRBs that compose interlace 2 for OFDM symbol #1 to #4.

In one embodiment, when operating in shared spectrum in semi-static channel access mode with useInterlacePUCCH-PUSCH configured, one or more of the following options could be considered:
The cancellation indication is modified so that to refer no longer to a group of PRBs, but to a group of interlaces, and this could be employed by defining a new field within DCI format 2_4 which is composed by 10 bits for 15 KHz SCS and 5 bits for 30 KHz SCS and 0 bits for 60 KHz. Each bit refers to a specific interlace, where for instance the LSB or MSB bit could refer to interlace #0. As an alternative, 6 bits could be used for 15 KHz by using an RIV based approach so signal the 10 interlaces. In this case, similar approach as in NR-U is used, where RIV values 0 . . . 54 indicate the starting interlace index and the number of consecutive interlace indices, while RIV values 55 . . . 63 indicate some predefined combinations, which are specified in the specification.

Through this field, a gNB may be able to explicitly indicate the interlace or group of interlaces within which an already scheduled transmission(s) should be cancelled within a specific set of symbols.

The RRC parameter timeFrequencyRegion is modified so that, when useInterlacePUCCH-PUSCH is configured, the field frequencyRegionForCI-r16 is still provided but may be ignored by the UE, but a new field may be included to explicitly indicate the interlace or group of interlaces within which an already scheduled transmission(s) should be cancelled. As an example, the timeFrequencyRegion is modified as follows:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| InterlaceForCI | BIT STRING (SIZE(N)) |
| deltaOffset-r16 | INTEGER (0..2), |

...
}

where InterlaceForCI is a bitmap, where each bit refers to a specific interlace, where for instance the LSB or MSB bit could refer to interlace #0, and where N is a fixed value which for example could be:
N=10;
N=10 for 15 KHz SCS, N=5 30 KHz SCS and N=0 for 60 KHz SCS.

As an alternative an RIV based approach could be used to signal the specific interlace or group of interlaces through InterlaceForCI, and N=6. In this case, similar approach as in NR-U is used, where RIV values 0 . . . 54 indicate the starting interlace index and the number of consecutive interlace indices, while RIV values 55 . . . 63 indicate some predefined combinations, which are specified in the specification.

In another option of this embodiment, additionally B_{CI} which is used in Rel. 16 to indicate the number of PRBs provided by frequencyRegionforCI in timeFrequencyRegion may be reinterpreted as the interlaces indicated by the InterlaceForCI.

In another option of this embodiment, additionally B_{CI}, which is used in Rel. 16 to indicate the number of PRBs provided by frequencyRegionforCI in timeFrequencyRegion, may be reinterpreted as the number of interlaces indicated by InterlaceForCI, and N_{BI} could be reinterpreted as the number of groups of interlaces. For example, if N_{BI}2, then, there are two groups of interlaces, where 1^{st} group of interlace is interlace 0 & 1, and 2^{nd} group of interlace is interlace 5&6.

The RRC parameter time FrequencyRegion is modified so that, when useInterlacePUCCH-PUSCH is configured, a new field may be included to explicitly indicate one interlace or group of interlaces within which an already scheduled transmission(s) should be cancelled. As an example, the timeFrequencyRegion is modified as follows:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| InterlaceForCI | INTEGER (0..X), |
| deltaOffset-r16 | INTEGER (0..2), |

...
}

where
X=9; or
X is calculated via an RIV based approach, which could be used to signal the specific interlace or group of interlaces. In particular, in this case, similar approach as in NR-U is used, where RIV values 0 . . . 54 indicate the starting interlace index and the number of consecutive interlace indices, while RIV values 55 . . . 63 indicate some predefined combinations, which are specified in the specification.

In another option of this embodiment, additionally B_{CI} which is used in Rel. 16 to indicate the number of PRBs provided by frequencyRegionforCI in timeFrequencyRegion may be reinterpreted as the interlaces indicated by the InterlaceForCI.

In another option of this embodiment, additionally B_{CI}, which is used in Rel. 16 to indicate the number of PRBs provided by frequencyRegionforCI in timeFrequencyRegion, may be reinterpreted as the number of interlaces indicated by the InterlaceForCI, and N_{BI} could be reinterpreted as the number of groups of interlaces. For example, if InterlaceForCI indicates interlace 0,1,5,6, then B_{CI}=4. Assume N_{BI=}2, then, there are two groups of interlaces, where 1^{st} group of interlace is interlace 0 & 1, and 2^{nd} group of interlace is interlace 5 & 6.

The RRC parameter timeFrequencyRegion is left as if and when useInterlacePUCCH-PUSCH is configured within the timeFrequencyRegion the parameter frequency RegionForCI is configured such that N_{BI} could be reinterpreted as the interlace index or the group of interlaces that the gNB intends to cancel. In one example N_{BI} is reinterpred as if this provides the RIV based indication of the interlaces, where RIV values 0 . . . 54 indicate the starting interlace index and the number of consecutive interlace indices, while RIV values 55 . . . 63 indicate some predefined combinations, which are specified in the specification.

In one embodiment, when operating in shared spectrum in semi-static channel access mode and regardless of whether useInterlacePUCCH-PUSCH is configured or not, the UE may not expect to be provided with a cancellation indication to cancel a transmission within a cancellation region that starts from the first symbol of a u-FFP (which represent the u-FFP boundary), when the UE should operate within that u-FFP as an initiating device. Alternatively, when operating in shared spectrum in semi-static channel access mode and regardless of whether useInterlacePUCCH-PUSCH is configured or not, the UE may not expect to be provided with a cancellation indication to cancel a transmission such that the latest symbol at which the cancelation may start does not overlap with the first symbol of a u-FFP (which represent the u-FFP boundary), when the UE should operate within that u-FFP as an initiating device.

In one embodiment, when operating in shared spectrum in semi-static channel access mode and regardless of whether useInterlacePUCCH-PUSCH is configured or not, the UE may not expect to be provided with a cancellation indication to cancel a transmission within a cancellation region that starts from the first symbol of a u-FFP (which represent the u-FFP boundary), regardless of when the UE should operate within that u-FFP as an initiating device or will operate as responding device. Alternatively, when operating in shared spectrum in semi-static channel access mode and regardless of whether useInterlacePUCCH-PUSCH is configured or not, the UE may not expect to be provided with a cancellation indication to cancel a transmission such that the latest symbol at which the cancelation may start does not overlap with the first symbol of a u-FFP (which represent the u-FFP boundary), regardless of when the UE should operate within that u-FFP as an initiating device or will operate as responding device.

In one embodiment, when operating in shared spectrum in semi-static channel access mode and regardless of whether useInterlacePUCCH-PUSCH is configured or not, the UE may expect that the cancellation indication is provided with a minimum offset to the start of the UL CI region in time domain to ensure a sufficient gap for the UE to perform the CCA. Thus, the cancellation indication may be provided with an additional OFDM symbol margin between the end of the CORESET in which the DCI format 2_4 is received, and the UL CI region as compared to operation in licensed spectra. In one option, this may not be necessary if the time domain resources related to a cancellation indication align with a u-FFP boundary.

In this matter, one of the following options could be adopted:
It is left up to gNB's implementation and scheduling to configure properly delta_Offset and UL transmissions so that a sufficient gap is always guaranteed for a UE when this is required to perform a CCA before transmitting, and mutual blocking across UEs would not occur especially when interlace-based resource allocation is used.
The value range that delta_Offset can assume is enhanced so that it can be configured with a wider range of value. As an example, delta_Offset is modified as follow:

| | |
|---|---|
| deltaOffset-r16 | INTEGER (0..3), |

The time between when the UE detects the DCI format 2_4 and the first symbol of the cancellation indication, T′_{proc,2}, is increased by changing the PUSCH processing capability.
   As an example: d_{2,1}=d_{offset}·2^{-μ}^{_{UL}}/2^{-μ}+1
   As another example: d_{2,1}=d_{offset}·2^{-μ}^{_{UL}}/2^{-μ}+Y, where Y corresponds to a number of OFDM symbol(s), including a fraction of an OFDM symbol at SCS corresponding to μUL, equivalent to 9, 16 or 25 us or equivalent to the lowest value between the UE's and gNB's idle period based on the specific configured FFP parameters.

In one embodiment, when operating in shared spectrum in semi-static channel access mode and regardless of whether useInterlacePUCCH-PUSCH is configured or not, in the first symbol belonging to the symbols within which the gNB would like to perform a cancellation (which corresponds to the UL cancellation region), all UEs that perform a transmission within that symbol (and within any interlace or group of interlace) would cancel their transmission, while for the remaining symbols only the UE(s) which performs a transmission(s) over the interlace or group of interlaces indicated by the cancellation indication would cancel its/their transmission(s).

In another embodiment, when operating in shared spectrum in semi-static channel access mode and regardless of whether useInterlacePUCCH-PUSCH is configured or not, in the first symbol belonging to the symbols within which the gNB would like to perform a cancellation, all UEs that perform a transmission within that symbol (and within any interlace or group of interlace) and for which the transmission would be a PUSCH with priority 0, if the UE is provided uplinkCancellationPriority, would cancel their transmission, while for the remaining symbols only the UE(s) which performs a transmission(s) over the interlace or group of interlaces indicated by the cancellation indication would cancel its/their transmission(s).

In another embodiment, when operating in shared spectrum in semi-static channel access mode and regardless of whether useInterlacePUCCH-PUSCH is configured or not, if the gNB provides a cancellation indication according which a cancellation of an interlace or group of interlace would need to occur starting from symbol X, then for all UEs or for only the UEs for which the transmission would be a PUSCH with priority 0, if the UE is provided uplinkCancellationPriority, their transmission must be stopped at least one symbol earlier or Y us earlier, where Y may be 9 us, 16 us, or 25 us.

### Extension to Multi-Carrier Operation

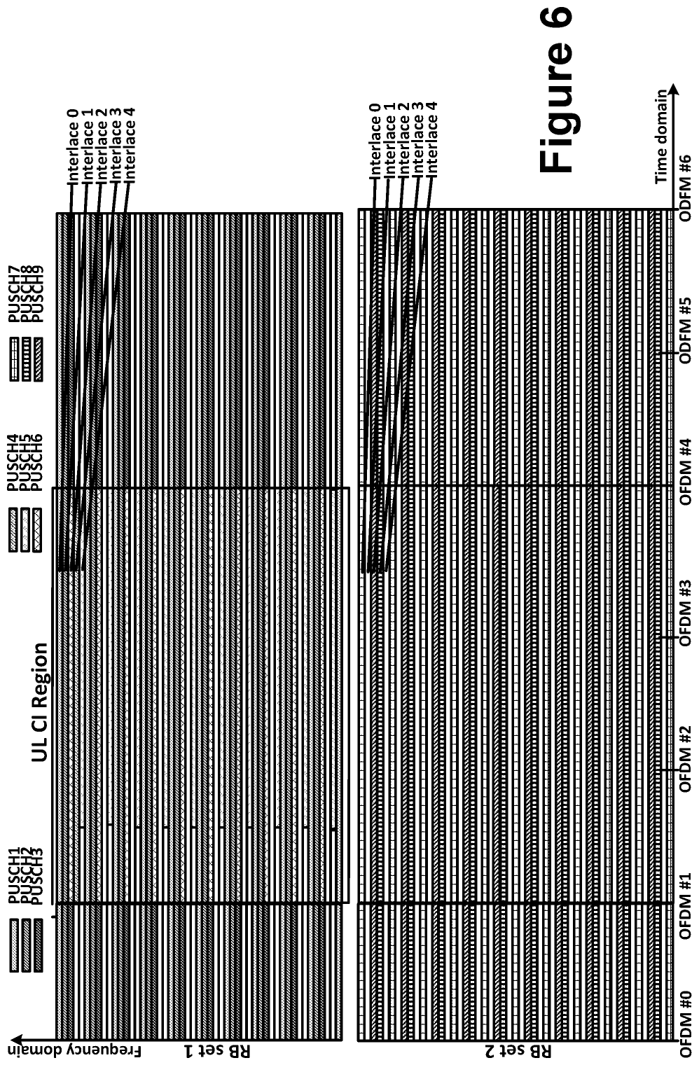

When operating in wideband mode, a UE may be scheduled to transmit different PUSCHs over different RB sets as illustrated in FIG. 6. In particular, when useInterlacePUCCH-PUSCH is configured, this would imply that with a specific interlace a plurality of PUSCH transmissions may occur over different RB sets. In this case, when a gNB may want to cancel a specific PUSCH may not need to cancel the entire interlace in this the PUSCH may lie, since this would lead to also cancel additional unwanted PUSCHs. Therefore, the cancellation indication may need to be enhanced to solve this additional issue.

Notice that similar issue may also occur if the COT initiator assumptions are not aligned across all the RB sets for which a UE is configured to transmit when operating in wideband mode.

In one embodiment, when operating in wideband mode over a shared spectrum and in semi-static channel access mode with useInterlacePUCCH-PUSCH configured, and the UE receives a cancellation indication carried in DCI 2_4 with a CI-RNTI, the UE would cancel a transmission or transmissions over an entire interlace or group of interlaces across all the RB sets if within the cancellation indication the indicated time-frequency resources that the gNB intends to cancel, which are indicated by timeFrequencyRegion, contain or refer to one or more PRBs belonging to that interlace or each of the interlaces within a group of interlaces.

As an example, let's consider FIG. 6. If the gNB would like to cancel PUSCH 3 in the symbols indicated by the UL CI region depicted in green (between ODFM symbol #1 and #4) to allow PUSCH6 to be performed, the gNB may be only required to provide a cancellation indication referring to at least one PRB of the 20 PRBs composing interlace 2, and would not need to provide cancellation indication for each PRB that compose that interlace, for the UE to cancel PUSCH 3 within those time/frequency resources. However, this would imply that PUSCH 9 would need to be cancelled as well within the same symbols.

As an alternative option of this embodiment, an additional indication for the RB set(s) over which the cancellation may need to be applied could be provided. In this matter the cancellation indication should include an additional field which explicitly indicates the RB set or RB sets over which the cancellation should be applied.
In one example, the RRC parameter timeFrequencyRegion is modified as follows:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| RBset | BIT STRING (SIZE(M)) |
| deltaOffset-r16 | INTEGER (0..2), |

...
}

where RBset is a bitmap, where each bit refers to a specific RB set.

In this case, the field R_{CI} could be introduced which indicates a specific RB subset of the sets provided by RBset.
In one example, the RRC parameter timeFrequencyRegion is modified as follow:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| RBset | INTEGER (SIZE(M)) |
| deltaOffset-r16 | INTEGER (0..2), |

...
}

where
X=9; or
X is calculated via an RIV based approach, which could be used to signal the specific interlace or group of interlaces. In particular, in this case, similar approach as in NR-U is used, where RIV values 0 . . . 54 indicate the starting interlace index and the number of consecutive interlace indices, while RIV values 55 . . . 63 indicate some predefined combinations, which are specified in the specification.

In one embodiment, when operating in shared spectrum in semi-static channel access mode with useInterlacePUCCH-PUSCH configured, and a UE is allocated a specific interlace for a transmission, for the UE to consider that interlace to be canceled within a specific laps of time, the UE is expected to receive a cancellation indication for each PRB that compose that interlace and for each RB set over which a transmission may span. In another example of the embodiment, when operating in shared spectrum in semi-static channel access mode with useInterlacePUCCH-PUSCH configured, and a UE is allocated a specific interlace for a transmission, the UE may be expected to cancel the interlace in an RB set if it receives cancellation indication for the interlace for the RB set over which a transmission may span.

As an example, let's consider FIG. 6. If the gNB would like to cancel PUSCH 3 in the symbols indicated by the UL CI region depicted in green, the gNB may need to provide a cancellation indication for each of 10 PRBs within RB set 1 for OFDM symbol #1 to #4 for the UE to cancel PUSCH 3 within those time/frequency resources.

In one embodiment, when operating in wideband mode one or more of the following options could be adopted:
The RRC parameter timeFrequencyRegion is modified so that when useInterlacePUCCH-PUSCH is configured the field frequencyRegionForCI-r16 is still carried or no longer carried or no longer expected, but two new fields will be included which explicitly indicates the interlace or group of interlaces within which an already scheduled transmission(s) should be cancelled and the RB set or RB sets over which the cancellation should be applied, respectively. As an example, the timeFrequencyRegion is modified as follows:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| InterlaceForCI | BIT STRING (SIZE(N)) |
| RBset | BIT STRING (SIZE(M)) |
| deltaOffset-r16 | INTEGER (0..2), |

...
}

where InterlaceForCI defined as in above embodiments, while RBset is a bitmap, where each bit refers to a specific RB set.

As another example example, the timeFrequencyRegion is modified as follows:

| | |
|---|---|
| timeFrequencyRegion-r16 | SEQUENCE { |
| timeDurationForCI-r16 | ENUMERATED {n2, n4, n7, n14} |

OPTIONAL, -- Cond SymbolPeriodicity

| | |
|---|---|
| timeGranularityForCI-r16 | ENUMERATED {n1, n2, n4, n7, n14, n28}, |
| frequencyRegionForCI-r16 | INTEGER (0..37949), |
| InterlaceForCI | INTEGER (0...X) |
| RBset | INTEGER (0...M) |
| deltaOffset-r16 | INTEGER (0..2), |

...

}

where
X=9; or
X is calculated via an RIV based approach, which could be used to signal the specific interlace or group of interlaces. In particular, in this case, similar approach as in NR-U is used, where RIV values 0 . . . 54 indicate the starting interlace index and the number of consecutive interlace indices, while RIV values 55 . . . 63 indicate some predefined combinations, which are specified in the specification.

Notice that the embodiments listed in this section are not mutually exclusive, and one or more of them may apply together.

### Enhancements to Priority-Based Transmissions

As mentioned along this disclosure, while during this working item RANI established the foundation for the framework to allow a UE to operate as initiating device in semi-static channel access mode, no discussions have been yet held on how to support priority-based transmissions when operating in Sub-6 GHz band. In this context, as previously discussed, it is important to align the current framework with the Rel. 16 dropping rules in order to solve the issues highlighted in FIG. 2 and FIG. 3 and discussed in this disclosure.

In order to solve the issue highlighted by FIG. 2, one of the following solutions could be chosen:
In one embodiment, a UE must always drop a LP transmission if this partially overlaps with the UE's FFP idle period, and the overlapping HP transmission aligns with the subsequent u-FFP during which the UE would operate as initiating device.
In one embodiment, if a LP transmission partially overlaps with the UE's FFP idle period, and the overlapping HP transmission aligns with the subsequent u-FFP during which the UE would operate as initiating device, a UE may be expected to cancel the transmission latest from the first symbol that overlaps with the idle period.
In one embodiment, a UE must always drop a LP transmission if this transmission together with the partially overlapping HP transmission may not fall within a g-FFP, and the HP transmission may align with a u-FFP boundary.
In one embodiment, it is left up to gNB's scheduling to make sure that a LP transmission may never impair a UE from transmitting a partially overlapping HP transmission and/or impair a UE from acquiring a following u-FFP within which the HP transmission may fall.

In order to solve the issue highlighted by FIG. 3, one of the following solutions could be chosen:
In one embodiment, if a LP transmission starts at the u-FFP boundary during which the UE would operate as an initiating device, a UE is expected to always follow the scheduling decisions and is always expected to transmit a LP transmission up to the first symbol that overlaps with a HP transmission.
In one embodiment, if a LP transmission starts at the u-FFP boundary during which the UE would operate as an initiating device, and if a HP CG transmission partially overlaps with a CG transmission with lower priority, the UE may always transmit the LP transmission up to the first symbol that overlaps with a HP transmission.

Notice that the embodiment listed here are not mutually exclusive, and one or more of them may apply together.

### Details for Intra-Symbol Starting Positions for CG-UE

As mentioned along this disclosure, given that in semi-static channel access mode when a UE operates as an initiating device, this may need to perform a CCA during an idle period prior to the start of a new FFP and start transmitting an UL burst exactly from the u-FFP boundary, then the concept of intra-symbol starting position may need to be modified. In fact, if the UE is instructed to start its transmission at different instance of time that the u-FFP boundary, then the UE may violate the ETSI BRAN requirements according with a device must not transmit within an idle-period or upon successful CCA the device must immediately transmit.

In one embodiment, for semi-static channel access mode, the UE never applies or is never configured and/or is never expected to be configured with the parameters contained within CG-StartingOffsets-r16. This means that when operating in shared spectrum with semi-static channel access mode, a CG UE always starts its transmission starting from the beginning of an OFDM symbol, and no concept of intra-symbol starting position is applied when the UE operates in both full and partial BW mode, regardless of whether this operates as initiating or responding device.

In one embodiment, for semi-static channel access mode, while a UE is expected to be configured with ('G-StartingOffsets-r16, it applies one or more of the following rules:
(1) The UE does not apply CG-StartingOffsets-r16 for any CG PUSCH which should be transmitted as if the UE operates as initiating device and it is aligned with a u-FFP boundary regardless of whether the UE is configured to operate in partial or full bandwidth, while it applies the intra-symbol starting position concept in all other cases.
(2) The UE does not apply CG-StartingOffsets-r16 for any CG PUSCH which is aligned with a u-FFP boundary regardless of whether the UE is configured to operate in partial or full bandwidth or as initiating or responding device, while it applies the intra-symbol starting position concept in all other cases.
(3) The UE does not apply CG-StartingOffsets-r16 for any CG PUSCH which should be transmitted as if the UE operates as initiating device and it is aligned with a u-FFP boundary only for the case when a UE is configured to operate in full BW, while it applies the intra-symbol starting position concept in all other cases.
(4) The intra-symbol starting position provided by cg-StartingFullBW-InsideCOT-r16 and/or cg-StartingPartialBW-InsideCOT-r16 is applied to a CG PUSCH if this falls within a g-FFP, and the UE operates as a responding device.
(5) The intra-symbol starting position provided by cg-StartingFullBW-OutsideCOT-r16 and/or cg-StartingPartialBW-OutsideCOT-r16 is applied to a CG PUSCH if this is not aligned with u-FFP boundary and the UE operates as initiating device.
(6) The intra-symbol starting position provided by cg-StartingFullBW-OutsideCOT-r16 and/or cg-StartingPartialBW-OutsideCOT-r16 is applied to a CG PUSCH if this is not aligned with u-FFP boundary and the UE operates as initiating device.
(7) The intra-symbol starting position provided by cg-StartingFullBW-OutsideCOT-r16 and/or cg-StartingPartialBW-OutsideCOT-r16 is applied to a CG PUSCH if this is not aligned with u-FFP boundary regardless of whether the UE operates as initiating or responding device.

### Details On the Timeline for Segmentation Across the Idle Period

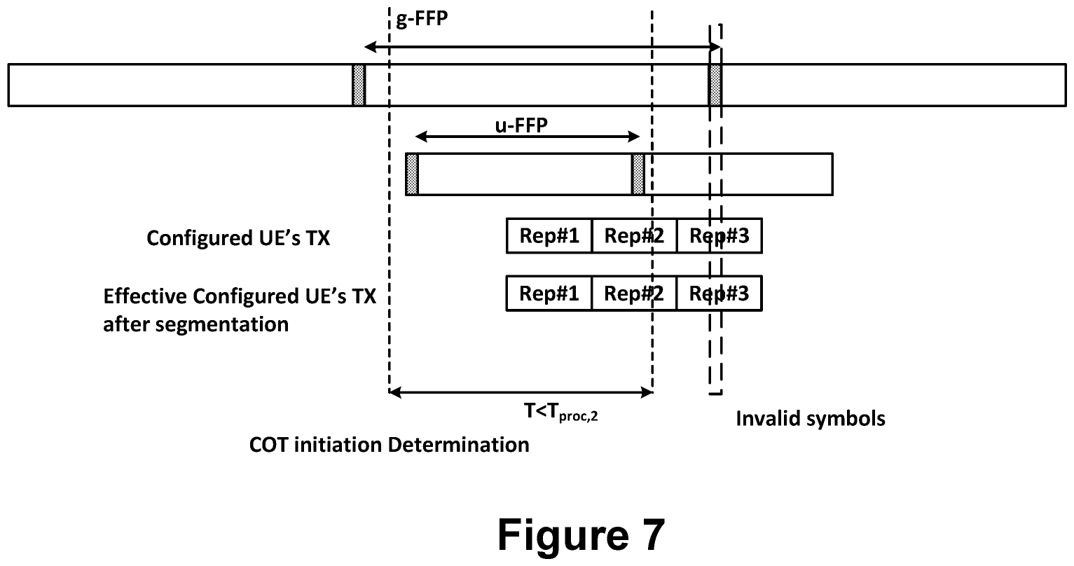

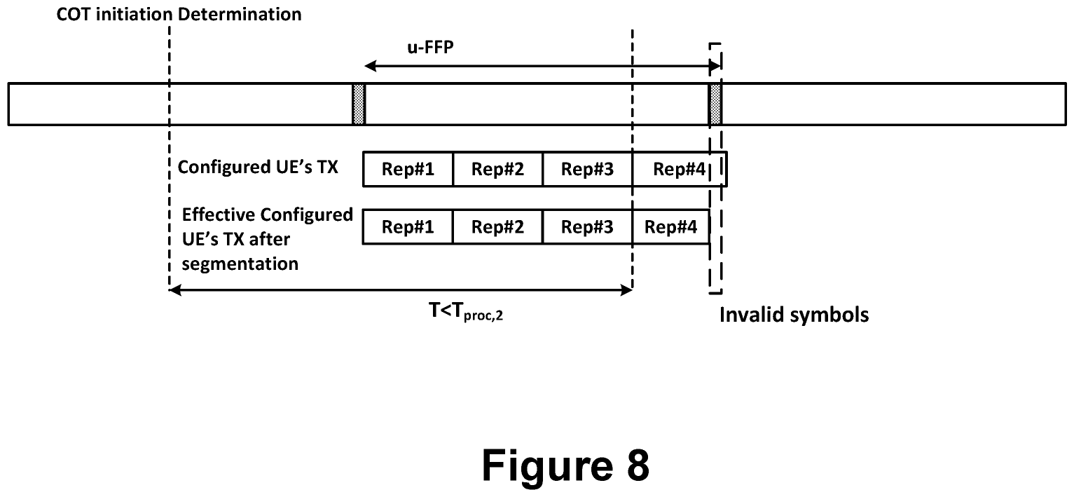

When the system operates in semi-static channel access mode, and the UE is provided with the u-FFP parameters and configured with PUSCH repetition type B, if a UE operates as responding device and the nominal repetition overlaps with a set of symbols belonging to the idle period associated to the gNB's FFP (illustrated in FIG. 7) or the UE operates as initiating device and the nominal repetition overlaps with a set of symbols belonging to the UE's idle period (illustrated in FIG. 8), all the symbols in the idle period should be considered as invalid symbols, and are not considered for an actual repetition. In the following of this disclosure, this process is referred as “segmentation across the idle period”.

FIG. 7 illustrates an example of a case when a UE operates as a responding device and the nominal repetition overlaps with a set of symbols belonging to the idle period associated to the gNB's FFP. In this specific case, the UE is configured to perform three back-to-back repetitions, and the time between when the UE determines that Rep #3 should be performed (instant of time when the UE performs COT initiation determination) as if the UE operates as a responding device and the first symbol of this nominal repetition, indicated by T, is smaller than the PUSCH preparation time T_{proc,2}(T<T_{proc,2}).

FIG. 8 illustrates an example of a case when a UE operates as an initiating device and the nominal repetition overlaps with a set of symbols belonging to the UE's idle period. In this specific case, the UE is configured to perform four back-to-back repetitions, and the time between when the UE determines that Rep #4 should be performed as if the UE operates as an initiating device (instant of time when the UE performs COT initiation determination) and the first symbol of this nominal repetition, indicated by T, is larger than the PUSCH preparation time T_{proc,2} (T<T_{proc,2}).

In one embodiment, if the time between when a UE determines (implicitly and/or explicitly) the COT initiator assumption (e.g. whether the UE should operate as initiating or responding device) for a nominal repetition and the first symbol of that nominal repetition is smaller than then PUSCH preparation time T_{proc,2} for the corresponding PUSCH processing capability assuming d2, 1=1 and μ corresponds to the smallest SCS configuration, then one or more of the following is supported:
If the UE established that it must operate as an initiating device, and the nominal repetition overlaps with the UE's idle period, then the UE must drop that nominal repetition;
If the UE established that it must operate as an initiating device, and the nominal repetition overlaps with the UE's idle period, then the UE should not perform segmentation, and the whole nominal repetition is transmitted;
If the UE established that it must operate as an initiating device, and the nominal repetition overlaps with the UE's idle period, the UE is not expected to perform segmentation across the idle period, and the whole nominal repetition is transmitted;
If the UE established that it must operate as an initiating device, and the nominal repetition overlaps with the UE's idle period, it is left up to UE's implementation to prepare multiple PUSCH transmission in advance (one applying segmentation across the idle period and one without), and segmentation will be always applied when applicable (this means that even if the PUSCH timeline is not met, then the UE is still expected to segment across the idle period);
If the UE established that it must operate as a responding device, and the nominal repetition overlaps with the gNB's idle period, then the UE must drop that nominal repetition;
If the UE established that it must operate as a responding device, and the nominal repetition overlaps with the gNB's idle period, then the UE should not perform segmentation, and the whole nominal repetition is transmitted;
If the UE established that it must operate as a responding device, and the nominal repetition overlaps with the gNB's idle period, the UE is not expected to perform segmentation across the idle period, and the whole nominal repetition is transmitted;
If the UE established that it must operate as a responding device, and the nominal repetition overlaps with the gNB's idle period, it is left up to UE's implementation to prepare multiple PUSCH transmission in advance (one applying segmentation across the idle period and one without), and segmentation will be always applied when applicable (this means that even if the PUSCH timeline is not met, then the UE is still expected to segment across the idle period).

In one embodiment, a UE is not expected to perform any COT initiation assumption determination, if it assesses that the time between when it would assess COT initiation assumption and the first symbol of the PUSCH nominal repetition is less than T_{proc,2}, assuming d2, 1=1 and μ corresponds to the smallest SCS configuration. In this case the PUSCH nominal repetition should be dropped.

In one embodiment, a UE is not expected to perform any COT initiation assumption determination, if it assesses that the time between when it would assess COT initiation assumption and the first symbol of the PUSCH nominal repetition is less than T_{proc,2}, assuming d2, 1=1 and μ corresponds to the smallest SCS configuration, and if the nominal PUSCH repetition overlaps with the gNB's idle period. In this case the PUSCH nominal repetition should be dropped.

In one embodiment, a UE expects that the first symbol of the PUSCH nominal repetition is not before a symbol starting after T_{proc,2} after the time when it would assess COT initiation assumption. Alternatively, a UE expects that the first symbol of the PUSCH nominal repetition which overlaps with the idle period of COT initiator, e.g., gNB's idle period if gNB is the COT initiator, is not before a symbol starting after T_{proc,2} after the time when it would assess COT initiation assumption. In other words, a UE does not expect the PUSCH nominal repetition does not satisfy the above timing conditions.

Notice that the embodiment listed here are not mutually exclusive, and one or more of them may apply together.

### Systems and Implementations

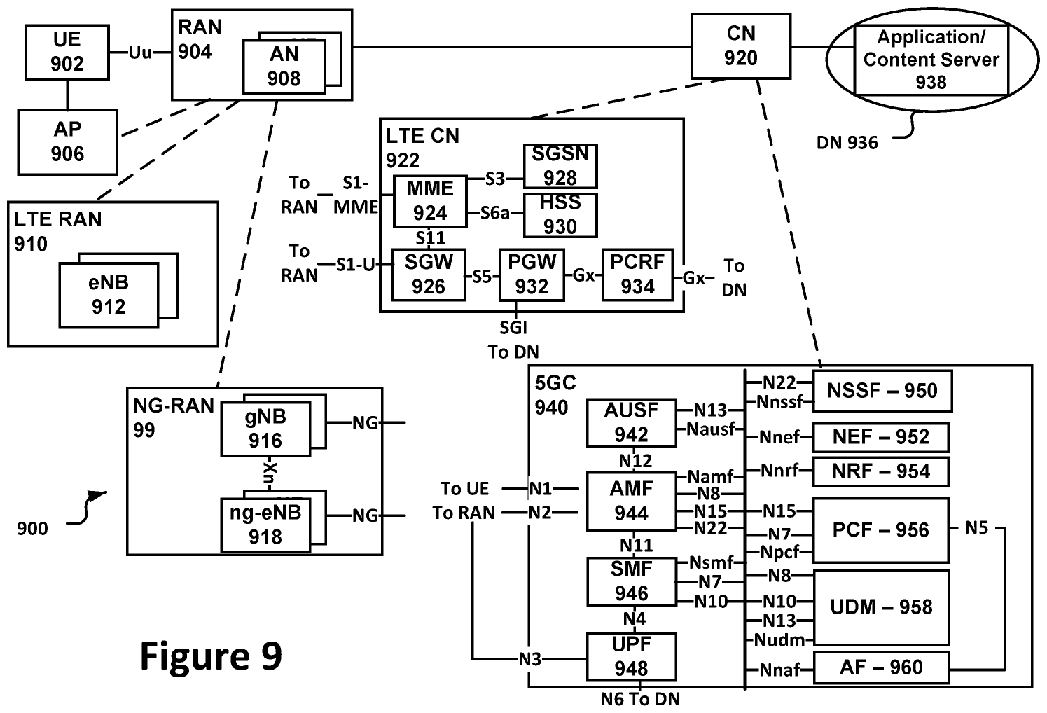

FIGS. 9-11 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be communicatively coupled with the RAN 904 by a Uu interface. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-FiR) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 KHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHZ 15 bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHZ. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 9 36 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate Qos and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF, AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating. UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3^{rd} party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

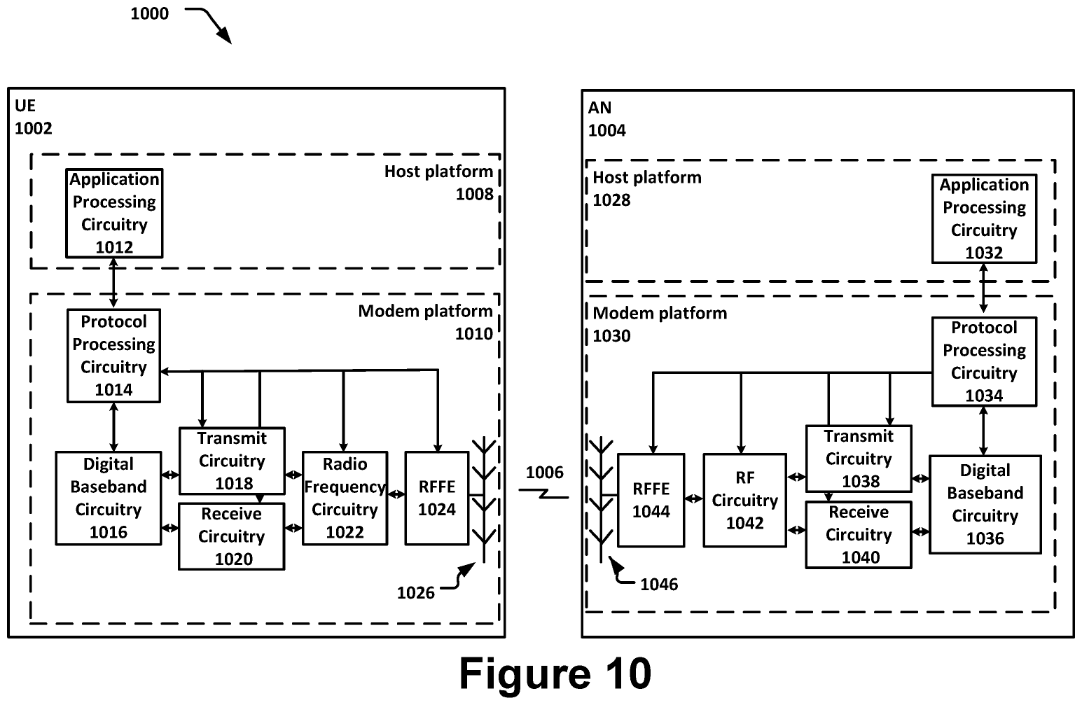

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHZ frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

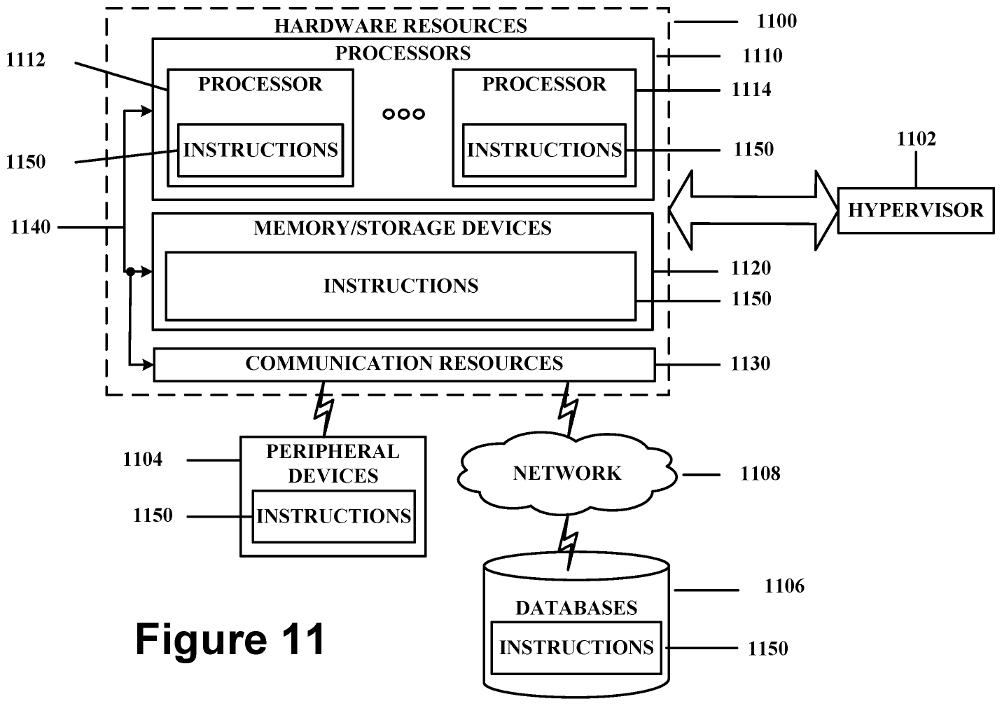

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### EXAMPLE PROCEDURES

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof.

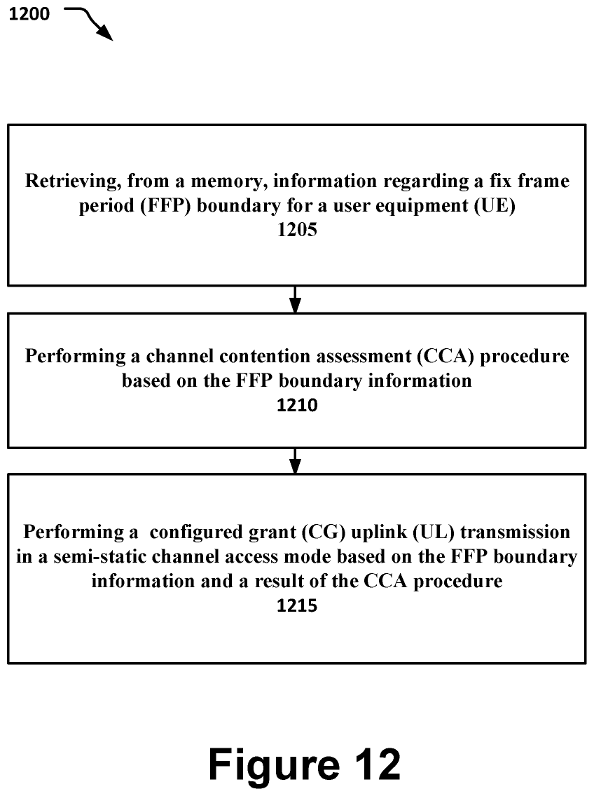

One such process is depicted in FIG. 12, which may be performed by a user equipment (UE) or portion thereof in some embodiments. In this example, process 1200 includes, at 1205, retrieving, from a memory, information regarding a fix frame period (FFP) boundary for the UE. The process further includes, at 1210, performing a channel contention assessment (CCA) procedure based on the FFP boundary information. The process further includes, at 1215, performing an uplink (UL) transmission in a semi-static channel access mode based on the FFP boundary information and a result of the CCA procedure.

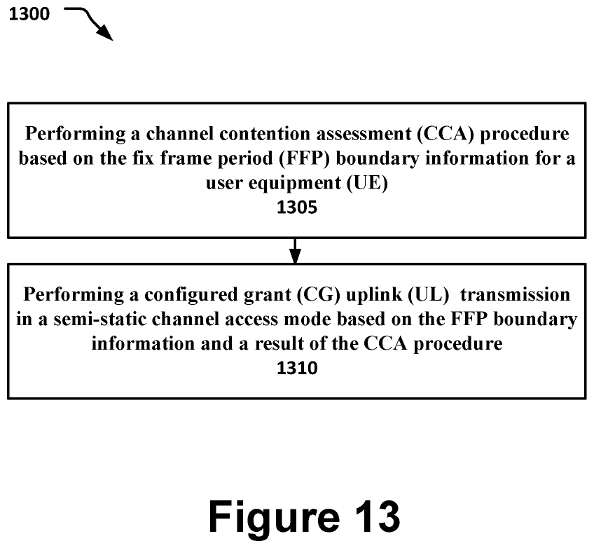

Another such process is depicted in FIG. 13. In this example, process 1300 includes, at 1305, performing a channel contention assessment (CCA) procedure based on the fix frame period (FFP) boundary information for a user equipment (UE). The process further includes, at 1310, performing an uplink (UL) transmission in a semi-static channel access mode based on the FFP boundary information and a result of the CCA procedure.

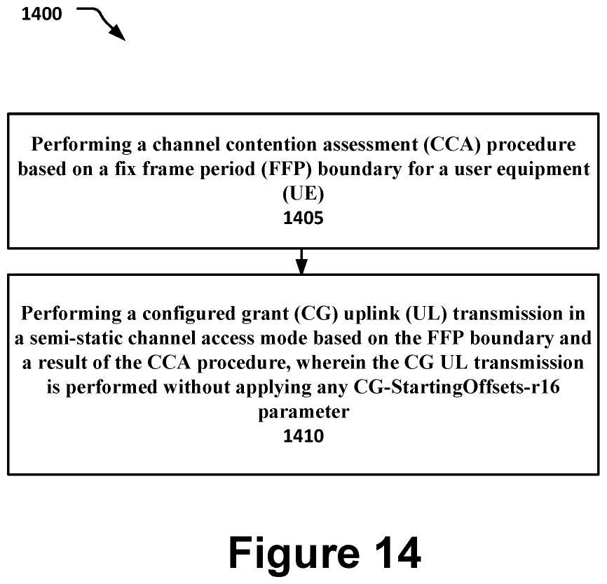

Another such process is depicted in FIG. 14, which may be performed by a UE in some embodiments. In this example, process 1400 includes, at 1405, performing a channel contention assessment (CCA) procedure based on a fix frame period (FFP) boundary for a user equipment (UE). The process further includes, at 1410, performing an uplink (UL) transmission in a semi-static channel access mode based on the FFP boundary and a result of the CCA procedure, wherein the UL transmission is performed without applying any CD-StartingOffsets-r16 parameter.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method to harmonize the cancellation indication procedure defined in Rel. 16 so that this works efficiently when the interlace-based resource allocation is used.

Example 2 may include the method of example 1 or some other example herein, several options are provided for the case when the system operates in single carrier operation with interlace-based resource allocation.

Example 3 may include the method of example 1 or some other example herein, several options are provided for the case when the system operates in multi-carrier operation with interlace-based resource allocation.

Example 4 may include the method for example 1 or some other example herein, several options are provided so that to make sure an UL transmission scheduled over cancelled resources is not blocked by previously scheduled transmissions, by ensuring a certain gap is always left before the transmission is initiated so that to perform the required channel access procedures.

Example 5 may include multiple options to ensure that the priority-based transmission rules introduced in Rel. 16 and Rel. 17 fit with the semi-static channel access framework defined in Rel. 17 to allow a UE to operate as initiating device.

Example 6 may include the method of example 5 or some other example herein, several dropping or cancellation rules are provided so that to avoid a LP transmission to block an HP transmission which partially overlaps with it.

Example 7 may include several options on how to apply the concept of intra-symbol starting position when a UE is allowed to operate as initiating device in semi-static channel access mode.

Example 8 may include the method of example 7 or some other example herein, different options are provided on how the UE should interpret CG-StartingOffsets-r16, within and without a FFP, and whether a UE is operating as initiating or responding device.

Example X1 includes an apparatus of a user equipment (UE) comprising:
memory to store information regarding a fix frame period (FFP) boundary for the UE; and
processing circuitry, coupled with the memory, to:
   retrieve the FFP boundary information from the memory;
   perform a channel contention assessment (CCA) procedure based on the FFP boundary information; and
   perform a configured grant (CG) uplink (UL) transmission in a semi-static channel access mode based on the FFP boundary information and a result of the CCA procedure.

Example X2 includes the apparatus of example X1 or some other example herein, wherein the CG UL transmission is performed without applying any CG-StartingOffsets-r16 parameter.

Example X3 includes the apparatus of example X1 or some other example herein, wherein the CG UL transmission is performed starting from a beginning of an orthogonal frequency division multiplexing (OFDM) symbol corresponding to a start of a channel occupancy time within an FFP.

Example X4 includes the apparatus of example X3 or some other example herein, wherein no intra-symbol starting position is applied to the CG UL transmission.

Example X5. The apparatus of claim 1, wherein the CCA procedure is performed during an idle period prior to a start of a new FFP.

Example X6 includes the apparatus of example X1 or some other example herein, wherein the CG UL transmission is performed from the FFP boundary.

Example X7 includes the apparatus of any of examples X1-X6 or some other example herein, wherein the UE operates as an initiating device in the semi-static channel access mode.

Example X8 includes one or more computer-readable media storing instructions that, when executed by one or more processors, configure a user equipment (UE) to:
perform a channel contention assessment (CCA) procedure based on a fix frame period (FFP) boundary for the UE; and
perform a configured grant (CG) uplink (UL) transmission in a semi-static channel access mode based on the FFP boundary and a result of the CCA procedure.

Example X9 includes the one or more computer-readable media of example X8 or some other example herein, wherein the CG UL transmission is performed without applying any CG-StartingOffsets-r16 parameter.

Example X10 includes the one or more computer-readable media of example X8 or some other example herein, wherein the CG UL transmission is performed starting from a beginning of an orthogonal frequency division multiplexing (OFDM) symbol that does not correspond to a start of a channel occupancy time within an FFP.

Example X11 includes the one or more computer-readable media of example X10 or some other example herein, wherein no intra-symbol starting position is applied prior to the CG UL transmission.

Example X12 includes the one or more computer-readable media of any one of examples X8-X11 or some other example herein, wherein the UE operates either as an initiating device or a responding device in the semi-static channel access mode.

Example X13 includes one or more computer-readable media storing instructions that, when executed by one or more processors, configure a user equipment (UE) to:
perform a channel contention assessment (CCA) procedure based on a fix frame period (FFP) boundary for the UE: and
perform a configured grant (CG) uplink (UL) transmission in a semi-static channel access mode based on the FFP boundary and a result of the CCA procedure, wherein the CG UL transmission is performed without applying any CG-StartingOffsets-r16 parameter.

Example X14 includes the one or more computer-readable media of example X13 or some other example herein, wherein the CG UL transmission is performed starting from a beginning of an orthogonal frequency division multiplexing (OFDM) symbol.

Example X15 includes the one or more computer-readable media of example X14 or some other example herein, wherein no intra-symbol starting position is applied prior to the CG UL transmission.

Example X16 includes the one or more computer-readable media of example X13 or some other example herein, wherein the CCA procedure is performed either during an idle period prior to a start of a new FFP or within an already-acquired FFP.

Example X17 includes the one or more computer-readable media of example X13 or some other example herein, wherein the CG UL transmission is performed either from the FFP boundary or from a beginning of an OFDM symbol within an already-acquired FFP.

Example X18 includes the one or more computer-readable media of any of examples X13-X17 or some other example herein, wherein the UE operates as either as an initiating device or a responding device in the semi-static channel access mode.

Example Z01 may include an apparatus comprising means to perform one or more elements of a method described in or related to any of examples 1-X18, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X18, or any other method or process described herein.

Example Z03 may include an apparatus comprising logic, modules, or circuitry to perform one or more elements of a method described in or related to any of examples 1-X18, or any other method or process described herein.

Example Z04 may include a method, technique, or process as described in or related to any of examples 1-X18, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X18, or portions thereof.

Example Z06 may include a signal as described in or related to any of examples 1-X18, or portions or parts thereof.

Example Z07 may include a datagram, packet, frame, segment, protocol data unit (PDU), or message as described in or related to any of examples 1-X18, or portions or parts thereof, or otherwise described in the present disclosure.

Example Z08 may include a signal encoded with data as described in or related to any of examples 1-X18, or portions or parts thereof, or otherwise described in the present disclosure.

Example Z09 may include a signal encoded with a datagram, packet, frame, segment, protocol data unit (PDU), or message as described in or related to any of examples 1-X18, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X18, or portions thereof.

Example Z11 may include a computer program comprising instructions, wherein execution of the program by a processing element is to cause the processing element to carry out the method, techniques, or process as described in or related to any of examples 1-X18, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell- specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time Rx Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### TERMINOLOGY

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry,” as used herein refers to, is part of, or includes circuitry that enables the exchange of information between two or more components or devices. The term “interface circuitry,” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-18. (canceled)

19. An apparatus of a user equipment (UE), the apparatus comprising:
memory to store information regarding a fix frame period (FFP) boundary for the UE; and
processing circuitry, coupled with the memory, to:
retrieve the FFP boundary information from the memory;
perform a channel contention assessment (CCA) procedure based on the FFP boundary information; and
perform a configured grant (CG) uplink (UL) transmission in a semi-static channel access mode based on the FFP boundary information and a result of the CCA procedure.

20. The apparatus of claim 19, wherein the CG UL transmission is performed without applying any CG-StartingOffsets-r16 parameter.

21. The apparatus of claim 19, wherein the CG UL transmission is performed starting from a beginning of an orthogonal frequency division multiplexing (OFDM) symbol corresponding to a start of a channel occupancy time within an FFP.

22. The apparatus of claim 21, wherein no intra-symbol starting position is applied to the CG UL transmission.

23. The apparatus of claim 19, wherein the CCA procedure is performed during an idle period prior to a start of a new FFP.

24. The apparatus of claim 19, wherein the CG UL transmission is performed from the FFP boundary.

25. The apparatus of claim 19, wherein the UE operates as an initiating device in the semi-static channel access mode.

26. One or more non-transitory computer-readable media storing instructions that, when executed by one or more processors, configure a user equipment (UE) to:
perform a channel contention assessment (CCA) procedure based on a fix frame period (FFP) boundary for the UE; and
perform a configured grant (CG) uplink (UL) transmission in a semi-static channel access mode based on the FFP boundary and a result of the CCA procedure.

27. The one or more non-transitory computer-readable media of claim 26, wherein the CG UL transmission is performed without applying any CG-StartingOffsets-r16 parameter.

28. The one or more non-transitory computer-readable media of claim 26, wherein the CG UL transmission is performed starting from a beginning of an orthogonal frequency division multiplexing (OFDM) symbol that does not correspond to a start of a channel occupancy time within an FFP.

29. The one or more non-transitory computer-readable media of claim 28, wherein no intra-symbol starting position is applied prior to the CG UL transmission.

30. The one or more non-transitory computer-readable media of claim 26, wherein the UE operates either as an initiating device or a responding device in the semi-static channel access mode.

31. One or more non-transitory computer-readable media storing instructions that, when executed by one or more processors, configure a user equipment (UE) to:
perform a channel contention assessment (CCA) procedure based on a fix frame period (FFP) boundary for the UE; and
perform a configured grant (CG) uplink (UL) transmission in a semi-static channel access mode based on the FFP boundary and a result of the CCA procedure, wherein the CG UL transmission is performed without applying any CG-StartingOffsets-r16 parameter.

32. The one or more non-transitory computer-readable media of claim 31, wherein the CG UL transmission is performed starting from a beginning of an orthogonal frequency division multiplexing (OFDM) symbol.

33. The one or more non-transitory computer-readable media of claim 32, wherein no intra-symbol starting position is applied prior to the CG UL transmission.

34. The one or more non-transitory computer-readable media of claim 31, wherein the CCA procedure is performed either during an idle period prior to a start of a new FFP or within an already-acquired FFP.

35. The one or more non-transitory computer-readable media of claim 31, wherein the CG UL transmission is performed either from the FFP boundary or from a beginning of an OFDM symbol within an already-acquired FFP.

36. The one or more non-transitory computer-readable media of claim 31, wherein the UE operates as either as an initiating device or a responding device in the semi-static channel access mode.
